(19) United States
(12) Patent Application Publication
(10) Pub. No.: US 2026/0244073 A1
(43) Pub. Date: Aug. 20, 2026

(54) PARALLEL LOCAL CONTROL OF OPTICALLY ADDRESSED QUBITS

(71) Applicant: THE TRUSTEES OF PRINCETON UNIVERSITY, Princeton, NJ (US)

(72) Inventors: Jeffrey THOMPSON, Princeton, NJ (US); Bichen ZHANG, Princeton, NJ (US); Pai PENG, Plainsboro Township, NJ (US)

(21) Appl. No.: 19/119,861

(22) PCT Filed: Oct. 13, 2023
(86) PCT No.: PCT/US2023/035078

§ 371 Date: Apr. 10, 2025

Related U.S. Application Data
(60) Provisional application No. 63/416,109, filed on Oct. 14, 2022.

(51) Int. Cl. G02F 1/33; G02F 1/31; G06N 10/40

(52) U.S. Cl. CPC G02F 1/33; G02F 1/31; G06N 10/40; G02F 2203/50

(57) ABSTRACT

Disclosed are systems and techniques for generating and steering laser beams onto atoms for performing locally addressed quantum gate operations. A system may include (i) a high-speed acousto-optic modulator (AOM) for producing a single input beam, (ii) a phase-only spatial light modulator (SLM) for imprinting a phase pattern on the single input beam, the phase pattern being chosen such that after a lens positioned after the SLM, the single input beam is divided into a pattern of secondary beams that correspond to the positions of the atoms or ions in a quantum computer, the lens after the SLM being positioned so the secondary beams are focused to form an image on a digital micromirror device (DMD) amplitude modulator, (iii) a compensation grating after the DMD, in the path of the secondary beams, and (iv) an objective lens after the compensation grating to image the secondary beams onto an atomic array.

### CROSS-REFERENCE TO RELATED APPLICATIONS

The present application claims priority to U.S. Provisional Patent Application No. 63/416,109, filed Oct. 14, 2022, the contents of which are incorporated by reference herein in its entirety.

### STATEMENT REGARDING FEDERALLY SPONSORED RESEARCH OR DEVELOPMENT

This invention was made with government support under Grant No. W911NF-18-1-0215 awarded by the Army Research Office (ARO), Grant No. N00014-20-1-2426 awarded by the Office of Naval Research (ONR), and Grant No. W911NF-20-1-0021 awarded by the Defense Advanced Research Projects Agency (DARPA). The government has certain rights in the invention.

### TECHNICAL FIELD

The present disclosure relates to controlling local gate operations, and specifically to devices that allows multiple individual laser beams to be generated and steered onto an array of atoms for performing locally addressed quantum gate operations.

### BACKGROUND

Neutral atoms in tweezer arrays have recently emerged as a promising platform for quantum science and technology, with applications to quantum computing, many-body simulations, and metrology. One of the key advantages of neutral atom arrays is that near-term scalability is enabled by leveraging commercially available opto-electronic devices. For example, CMOS and CCD cameras have enabled parallel readout of hundreds of qubits, and liquid-crystal-on-silicon spatial light modulators (LCOS-SLM) and acousto-optic deflectors (AODs) allow the creation of arrays of thousands of tweezer traps, with dynamic reconfiguration. The resolution of these devices is approximately 1 megapixel, which is compatible with scaling beyond ten thousand tweezers.

However, scalable local control of gate operations is an outstanding challenge for neutral atom quantum computing. This challenge is shared by other optically addressed qubits such as trapped ions and solid-state defects. An ideal controller must be able to generate uniform arrays of focused spots, and quickly switch between arbitrary illumination patterns with high on/off contrast and low crosstalk between closely spaced sites. Furthermore, the controller must be able to operate at application-dependent wavelengths and intensities, which range from the UV to IR and often require milliwatts or more power per site.

Several types of solutions to this challenge have been demonstrated. For example, multi-channel acousto-optic modulators (MC-AOM) and acousto-optic modulator (AOM) arrays have been demonstrated in small arrays of up to 32 channels, but scaling to larger numbers requires assembly of many discrete optical and electronic components. Acousto-optic deflectors (AODs) have been used to demonstrate individual addressing of around 50 qubits in both 1D and 2D. However, they are limited to row or column addressing when generating multiple spots in parallel and suffer from limited contrast from nonlinear intermodulation effects. LCOS-SLMs can generate arbitrary illumination patterns, but have refresh rates of 60-120 Hz, much slower than the intrinsic gate times of atomic qubits. Faster spatial light control can be realized with digital micromirror devices (DMDs), but the efficiency is poor when used to generate sparse spot arrays. Very recent work has demonstrated gate controllers using novel photonic devices, including photonic integrated chips (PICs), and MEMS-based beam steering systems (MEMS-BSS). While PICs are promising for realizing very high switching speeds, they have not yet demonstrated a channel count beyond a few tens or characterized crosstalk between closely spaced spots. MEMS-BSS is promising for low crosstalk and extremely high contrast but has not demonstrated parallel control of more than two beams. Additionally, a recently proposed method combines an AOD with a segmented LCOS-SLM to achieve rapid site-selective control. This approach, although promising, has not been demonstrated experimentally.

### BRIEF SUMMARY

Various deficiencies are improved using the disclosed systems and techniques.

In various aspects, a system for generating and steering a plurality of laser beams onto an array of atoms for performing locally addressed quantum gate operations may be provided. The system may include an optional first modulator (such as a high-speed acousto-optic modulator (AOM), or electro-optic modulator) configured to produce a single input beam of light comprising pulses of laser light that control a gate operation. In some embodiments, the single input beam of light is generated by a pulsed laser. In some embodiments, at least one pulse of the pulses of laser light may be, e.g., at least 10 ns in length, and/or no more than 10 microseconds in length. The first modulator may be operably coupled to a single mode fiber to eliminate spatial effects. The system may include a second modulator (such as a phase-only spatial light modulator (SLM) or an acoustic-optical deflector (AOD)) configured to imprint a phase pattern on a received single input beam from the laser source and optional first modulator, the phase pattern being chosen such that after a lens positioned after the second modulator, the single input beam is divided into a pattern of secondary beams that correspond to the positions of the atoms or ions in a quantum computer, the lens after the second modulator being positioned so the secondary beams are focused to form an image on a third modulator (such as a digital micromirror device (DMD) amplitude modulator). The system may include a compensation grating after the third modulator, in the path of the secondary beams. The system may include an objective lens after the compensation grating, the objective lens configured to image the secondary beams onto an atomic array.

The pattern of secondary beams may include 10,000 secondary beams or less. In some embodiments, each of the secondary beams may be regularly spaced. In some embodiments, one or more of the secondary beams may be irregularly spaced. The pattern of secondary beams may include more than 10,000 secondary beams.

The third modulator may be configured to shut off a subset of the secondary beams. The system may be configured to allow the same gate operation to be implemented on any subset of the secondary beams in parallel. A power efficiency defined as the sum of the secondary beam powers divided by the incident primary beam power may be substantially constant as the number of secondary beams is varied. The third modulator may be configured to switch a pattern of secondary beams transmitted in no more than 30 microseconds. A secondary beam may be switched off at the third modulator, and its intensity in the plane of the atoms may be reduced by an average of at least 100,000 (50 dB). In some embodiments, an array of secondary beams with spacing equal to 4.6× beam waists or less are realized. In some embodiments, an array of secondary beams with spacing equal to 20× beam waists or less are realized.

In some embodiments, wherein (for example, at a spacing of 4.6× beam waists) the crosstalk in the image plane between a primary beam that is on and a neighboring site that is off may be, on average, 4e−5 (−43 dB) or less. The system may be configured for 1 W or less of incident power and at least one wavelength of 350 nm-2050 nm. The system may be configured for at least 1W of incident power, at one or more wavelengths 350 nm-2050 nm.

In various aspects, a method for generating and steering a plurality of laser beams onto an array of atoms for performing locally addressed quantum gate operations may be provided. The method may include producing pulses of laser light that are configured to control a gate operation, that is optionally coupled into a single mode fiber to eliminate spatial effects. The method may include imprinting a phase pattern on the beam, the phase pattern chosen such that after a lens, the single input beam is divided a pattern of secondary beams that correspond to the positions of the atoms or ions in a quantum computer. The method may include focusing the secondary beams to form an image on a digital micromirror device (DMD) amplitude modulator. The method may include flipping one or more mirrors on the DMD on or off to turn on or off individual beams of the secondary beams in the reflection from the DMD. The method may include re-imaging the beams reflected from the DMD onto a plane of atoms or ions making up a quantum computer.

An angle of incidence onto the DMD may be chosen such that the reflected beam satisfies a blazing condition, so the reflected light is concentrated in a single diffraction order. A DMD plane may not be perpendicular to the propagation direction of the light from a phase-only spatial light modulator (SLM) configured to imprint the phase pattern. The method may include passing the beams reflected from the DMD through a telescope and a compensation grating. The method may include using an objective lens to image the secondary beams onto a target, such as an atomic array.

The parameters of the telescope (magnification M) and the compensation grating

$$( {β}_{G} = \frac{cos ( {θ}_{r , G} )}{cos ( {θ}_{i , G}} )$$

may be chosen to minimize the following defocus in the image plane:

$${δ}_{x , I}^{′} = M [ M sin ( {θ}_{i , D} ) {β}_{D}^{2} {β}_{G}^{2} - M sin ( {θ}_{r , D} ) {β}_{G}^{2} + \frac{cos ( {θ}_{r , D} )}{cos ( {θ}_{i , D} )} [ sin ( {θ}_{i , G} ) {β}_{G}^{2} - sin ( {θ}_{r , G} ) ] ] X ,$$

$${δ}_{y , I}^{′} = M [ M sin ( {θ}_{i , D} ) - M sin ( {θ}_{r , D} ) + \frac{cos ( {θ}_{r , D} )}{cos ( {θ}_{i , D} )} [ sin ( {θ}_{i , G} ) - sin ( {θ}_{r , G} ) ] ] X .$$

In some embodiments, a compensation grating may not be used and instead a SLM may be used to pre-compensate the defocus and astigmatism introduced by the DMD, by applying a site-dependent wavefront correction to the secondary beams. In some embodiments, a SLM may be used to apply a site-dependent wavefront correction to the secondary beams to maintain a tight focus across the entire DMD aperture.

### BRIEF DESCRIPTION OF DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a schematic illustration of an embodiment of a system.

FIGS. 2A and 2B are illustrations of a DMD switching on (2A) or off (2B) a secondary spot by satisfying (2A) or violating (2B) a blazing condition.

FIGS. 3A and 3B are histograms of beam waist values in the x direction (wₓ) (3A) and in the y direction (w_{y}) (3B), for each site in the array. The spot parameters are obtained by fitting the camera image to a 2D Gaussian function, and the widths are normalized to the average beam waist among the central 100 sites, w₀=17.2 μm.

FIG. 3C is a histogram of spot intensities across the array, normalized to the mean intensity, The spot parameters are obtained by fitting the camera image to a 2D Gaussian function.

FIGS. 4A-4C are cross sections of the normalized intensity when a row of spots (4A) with a minimal spacing of 4.6w₀, every other spot (4B), and a single spot (4C) are on. The residual intensity error (crosstalk and 1/contrast) on the nearest neighbor along the cut direction is approximately 4×10⁻⁵ (−44 dB). The sites far from the illuminated site show a relative intensity of 2.4×10⁻⁵ (−46 dB). The grey-shaded area at the bottom of FIG. 4C represents the noise floor of the HDR images.

FIG. 5A is a noise spectrum of a single spot.

FIG. 5B is a normalized photodiode response by triggering an example DMD at 43.5 kHz (frame time T=23 μs). The two curves show the output intensity of a single spot when the AOM is in (i) “always-on” or (ii) pulsed mode. The frame rate is limited to 47 kHz by the speed of data transfer to the DMD.

FIG. 5C is a graph showing an overlapped zoom-in area (21.5 μs-23.5 μs) of two frames. The traces show a photodiode response of a frame whose next frame is (i) on or (ii) off.

FIG. 5D is a graph showing a photodiode response histogram with a 2-million-flip pseudorandom bit sequence applied on the DMD showing no bit error (error rate upper bound 5.1×10⁻⁷).

FIG. 6 is a graph showing an x direction cross-section of the normalized intensity when a single channel is switched on. Dotted vertical lines represent the neighboring channels. Points represent (i) post-aberration and (ii) pre-aberration correction data. Shaded area shows the contribution of finite on/off contrast.

FIG. 7A is an illustration of system aberrations arising from the tilted optical axes. The focal planes of the imaging system do not align with the DMD or image planes. Grey box illustrates the DMD aperture width W.

FIG. 7B is an illustration of aberration correction using a compensation grating.

FIG. 7C is a depiction of a grating altering the effective focal point within the xz plane. A transmission grating is drawn here for clarity, reducing figure congestion. This concept also extends to reflective gratings.

FIG. 8 is a schematic showing the physical dimensions of the micromirror array used in an FDTD simulation.

FIG. 9 is a schematic illustration of an alternate embodiment of a system

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Disclosed is a new approach to generating large-scale arrays of individually controlled laser beams for local gate operations. It is based on a combination of three modulators, used in series to implement separate functions on separate timescales. First, an AOM is used to generate a pulse of light with the desired frequency and waveform in a single spatial mode, with nanosecond-scale temporal resolution. Then, an LCOS-SLM diffracts the pulse into an array of secondary beams at fixed positions, corresponding to the qubit locations. Finally, a DMD placed in an image plane is used to selectively shutter the secondary beams, which determines which subset of the qubits are ultimately illuminated; the DMD can be reconfigured to illuminate different subsets of qubits every, e.g., 21 μs. This approach can achieve an extremely high extinction ratio by operating the DMD as a diffraction grating, with locally switchable blazing angle.

One challenge is controlling aberrations arising from diffracting tightly focused beams with the DMD, which results in site-to-site crosstalk and limits the spot size uniformity. One can analytically design and implement a correction system consisting of a telescope and a ruled grating. With this approach, an example array of 10,000 beams separated by 4.6w₀ (where w₀ is the 1/e² radius), with 10% uniformity in the beam waist and 2% uniformity in the intensity across the array, can be created. The average on/off contrast of each site in the example array is 46 dB, and the average crosstalk between nearest-neighbor sites is −44 dB.

In various aspects, a system for generating and steering a plurality of laser beams onto an array of atoms for performing locally addressed quantum gate operations may be provided. The disclosed systems may be suitable for controlling parallel gate operations in large-scale neutral atom arrays. Such system can be employed to focus gate beams directly (i.e., drive atomic transitions) or to apply local light shifts, which is a particularly robust approach for nuclear spin qubits in alkaline earth atoms. This device is also useful for other systems such as trapped ions and solid-state defects, and other applications including quantum simulation and atomic clocks or other sensors.

One basic setup of the controller may include a first modulator (such as an AOM), which generates pulses with nanosecond-scale timing resolution, a second modulator (such as an LCOS-SLM) that splits the primary laser beam into thousands of secondary beams of an arbitrary, static geometry by imprinting the phase in the Fourier plane, and a third modulator (such as a DMD), which acts as an optical switch array to rapidly activate or deactivate specific subsets of the secondary beams.

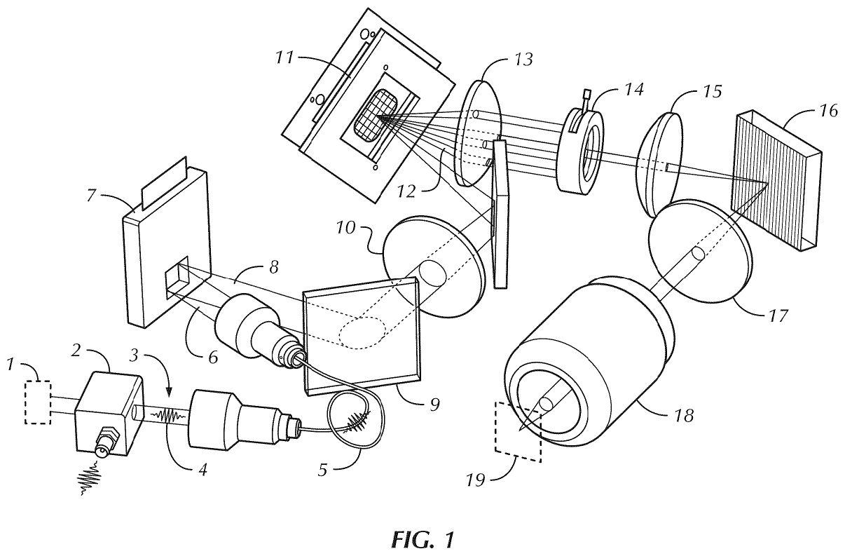

Referring to FIG. 1, the system may include a laser source 1 configured to generate a laser beam. The laser beam may be directed to an optional first modulator 2.

As will be understood, the laser source may be configured for any incident power, and any wavelength.

In some embodiments, the system may be configured to use a laser source with an incident power of 100 W or less. In some embodiments, the system may be configured to use a laser source with an incident power of 10 W or less. In some embodiments, the system may be configured to use a laser source with an incident power of 1 W or less. In some embodiments, the system may be configured to use a laser source with an incident power of 100 mW or less. In some embodiments, the system may be configured to use a laser source with an incident power of 10 mW or less. In some embodiments, the system may be configured to use a laser source with an incident power of at least 10 W or less. In some embodiments, the system may be configured to use a laser source with an incident power of at least 1 W. In some embodiments, the system may be configured to use a laser source with an incident power of at least 100 mW. In some embodiments, the system may be configured to use a laser source with an incident power of at least 10 mW. In some embodiments, the system may be configured to use a laser source with an incident power of at least 1 mW.

In some embodiments, the system may be configured to use one or more wavelengths from 350 nm-10 μm. In some embodiments, the system may be configured to use one or more wavelengths of light in the visible light spectrum (e.g., approximately 380 nm to about 750 nm). In some embodiments, the system may be configured to use one or more wavelength of light in the near-infrared spectrum (e.g., about 750 nm to about 1.4 μm). In some embodiments, the system may be configured to use one or more wavelength of light in the short wavelength infrared spectrum (e.g., about 1.4 μm to about 3 μm). In some embodiments, the system may be configured to use one or more wavelength of light in the mid-wavelength infrared spectrum (e.g., about 3 μm to about 8 μm). In some embodiments, the system may be configured to use one or more wavelength of light in the mid-wavelength infrared spectrum (e.g., about 8 μm to about 15 μm). In some embodiments, the system may be configured to use one or more wavelength of light from 350 nm-2050 nm.

In some embodiments, the system may be configured to use one or more wavelength of light of at least 10 nm. In some embodiments, the system may be configured to use one or more wavelength of light of at least 100 nm. In some embodiments, the system may be configured to use one or more wavelength of light of at least 200 nm. In some embodiments, the system may be configured to use one or more wavelength of light of at least 300 nm. In some embodiments, the system may be configured to use one or more wavelength of light of at least 350 nm. In some embodiments, the system may be configured to use one or more wavelength of light of at least 400 nm. In some embodiments, the system may be configured to use one or more wavelength of light of at least 500 nm. In some embodiments, the system may be configured to use one or more wavelength of light of at least 600 nm. In some embodiments, the system may be configured to use one or more wavelength of light of at least 700 nm. In some embodiments, the system may be configured to use one or more wavelength of light of at least 800 nm. In some embodiments, the system may be configured to use one or more wavelength of light of at least 900 nm. In some embodiments, the system may be configured to use one or more wavelength of light of at least 1000 nm. In some embodiments, the system may be configured to use one or more wavelength of light of no more than 6000 nm. In some embodiments, the system may be configured to use one or more wavelength of light of no more than 5000 nm. In some embodiments, the system may be configured to use one or more wavelength of light of no more than 4000 nm. In some embodiments, the system may be configured to use one or more wavelength of light of no more than 3000 nm. In some embodiments, the system may be configured to use one or more wavelength of light of no more than 2050 nm. In some embodiments, the system may be configured to use one or more wavelength of light of no more than 1500 nm. In some embodiments, the system may be configured to use one or more wavelength of light of no more than 1400 nm. In some embodiments, the system may be configured to use one or more wavelength of light of no more than 1300 nm. In some embodiments, the system may be configured to use one or more wavelength of light of no more than 1200 nm. In some embodiments, the system may be configured to use one or more wavelength of light of no more than 1100 nm. In some embodiments, the system may be configured to use one or more wavelength of light of no more than 1000 nm.

In some embodiments, the system may be configured to use a plurality of wavelengths from 350 nm-2050 nm. In some embodiments, the system may be configured to use a one or more wavelengths from 350 nm-650 nm and one or more wavelengths from 650 nm-1000 or 1100 nm. In some embodiments, the system may be configured to use a one or more wavelengths from 350 nm-650 nm, one or more wavelengths from 650 nm-1100 nm, and one or more wavelengths from 1100 nm-1500 or 1600 nm. In some embodiments, the system may be configured to use a one or more wavelengths from 350 nm-650 nm, one or more wavelengths from 650 nm-1100 nm, one or more wavelengths from 1100 nm-1600 nm, and one or more wavelengths from 1600 nm-2050 nm.

In some embodiments, the laser source may be a pulsed laser. The pulses may be configured to control a gate operation.

In some embodiments, such as if the light beam from the laser source is not already a single beam of pulses of laser light, a first modulator may be utilized. The first modulator may be configured to produce a single input beam of light 3 comprising pulses of laser light 4 that are configured to control a gate operation. Various modulators known in the art may be used to accomplish this. The first modulator may be a high-speed acousto-optic modulator (AOM) or an electro-optic modulator (EOM).

There is no restriction on the length of the pulses. The minimal length may be limited by, e.g., the AOM rising time. In some embodiments, at least one pulse of the pulses of laser light may be at least 10 ns in length. In some embodiments, at least one pulse of the pulses of laser light may be at least 20 ns in length. In some embodiments, at least one pulse of the pulses of laser light may be at least 30 ns in length. In some embodiments, at least one pulse of the pulses of laser light may be no more than 35 ns in length. In some embodiments, at least one pulse of the pulses of laser light may be no more than 30 ns in length. In some embodiments, at least one pulse of the pulses of laser light may be no more than 25 ns in length. In some embodiments, each pulse may be at least 10 ns in length. In some embodiments, each pulse may be at least 20 ns in length. In some embodiments, each pulse may be at least 30 ns in length. In some embodiments, each pulse may be no more than 35 ns in length. In some embodiments, each pulse may be no more than 30 ns in length. In some embodiments, each pulse may be no more than 25 ns in length. In some embodiments, at least one pulse of the pulses of laser light may be no more than 10 microseconds in length. In some embodiments, each pulse may be no more than 10 microseconds in length.

The first modulator may be operably coupled to a single mode fiber 5. The single mode fiber may be used for various purposes, such as, e.g., to eliminate spatial effects.

The system may include a second modulator 7. The second modulator may be operably coupled to the laser source and optional first modulator 2. The second modulator may be, e.g., one or more phase-only spatial light modulators (SLMs) and/or one or more acoustic-optical deflectors (AODs). The second modulator may be configured to imprint a phase pattern on the single input beam 6. The phase pattern may be chosen such that after a lens 10 positioned after the second modulator, the single input beam is divided into a pattern of secondary beams 8 that correspond to the positions of the atoms or ions in a quantum computer.

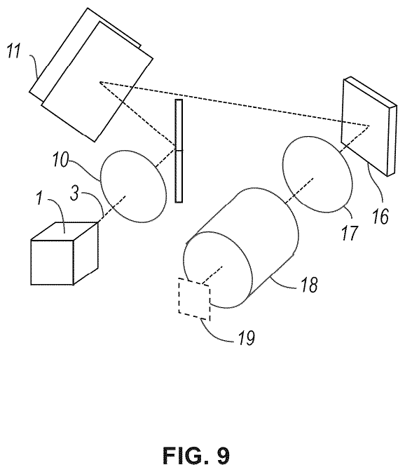

Referring briefly to FIG. 9, in some embodiments, the system may be free of a first modulator, and the laser beam may be directed to a second modulator.

The pattern of secondary beams may include any number of secondary beams. In some embodiments, the pattern of secondary beams may include 5,000 secondary beams or less. In some embodiments, the pattern of secondary beams may include 10,000 secondary beams or less. In some embodiments, the pattern of secondary beams may include 50,000 secondary beams or less. In some embodiments, the pattern of secondary beams may include 100,000 secondary beams or less. In some embodiments, the pattern of secondary beams may include more than 1,000 secondary beams. In some embodiments, the pattern of secondary beams may include more than 5,000 secondary beams. In some embodiments, the pattern of secondary beams may include more than 10,000 secondary beams. In some embodiments, the pattern of secondary beams may include more than 15,000 secondary beams. In some embodiments, each of the secondary beams may be regularly spaced. In some embodiments, one or more of the secondary beams may be irregularly spaced (that is, a distance between a first beam and a second, adjacent beam may be different from a distance between the first beam and a third, also adjacent, beam).

In some embodiments, an array of secondary beams with spacing equal to 4.6× beam waists or less are realized. In some embodiments, an array of secondary beams with spacing equal to 20× beam waists or less are realized.

The lens 10 after the second modulator may be positioned so the secondary beams 8 are focused to form an image on a third modulator 11 (such as a digital micromirror device (DMD) amplitude modulator). The system may include one or more additional lenses and/or mirrors 9 between the second modulator and the third modulator.

The third modulator may be configured to shut off a subset of the secondary beams. In one example, the DMD (e.g., a DLP7000® Type A DMD from Texas Instruments) is an array of approximately 1 million micromirrors (with a=13.68 μm pitch) that can be switched between two, fixed tilt angles (θ_{b}=±12.35°). Under coherent illumination from a laser, the DMD acts as a diffraction grating. The angle of incidence to satisfy a blazing condition when the mirrors are in the +12.35° state, such that the reflected light is concentrated into a single outgoing diffracted order. When the mirrors are in the off state, the reflected light is spread out between many orders. Provided the beam waist (w₀) on the DMD is larger than the mirror pitch, the angular separation between the diffraction orders is larger than the divergence of the focused beams, allowing the unwanted orders to be blocked by a spatial filter. In some embodiments, beam waist (w₀) may be greater than the mirror pitch (a). In some embodiments, w₀≥1.1a. In some embodiments, w₀≥1.2a. In some embodiments, w₀≥1.3a. In some embodiments, w₀≥1.4a. In some embodiments, w₀≤10a. In some embodiments, w₀≤5a. In some embodiments, w₀≤3a. In some embodiments, w₀≤2a. In some embodiments, w₀≤1.9a. In some embodiments, w₀≤1.8a In some embodiments, w₀≤1.7a. In some embodiments, w₀≤1.6a. In this example, the beam waist (w₀) on the DMD was 20.4 μm=1.49a.

In some embodiments, the system may be configured to allow the same gate operation to be implemented on any subset of the secondary beams in parallel. That is, in some embodiments, since the pulses of light define gate operations, the third modulator controls which spots are turned on or off. Each secondary beam spans across a group of micromirrors, so that the third modulator can individually control each spot in an array separately, allowing the same operation to be implemented on any subset of beams in parallel.

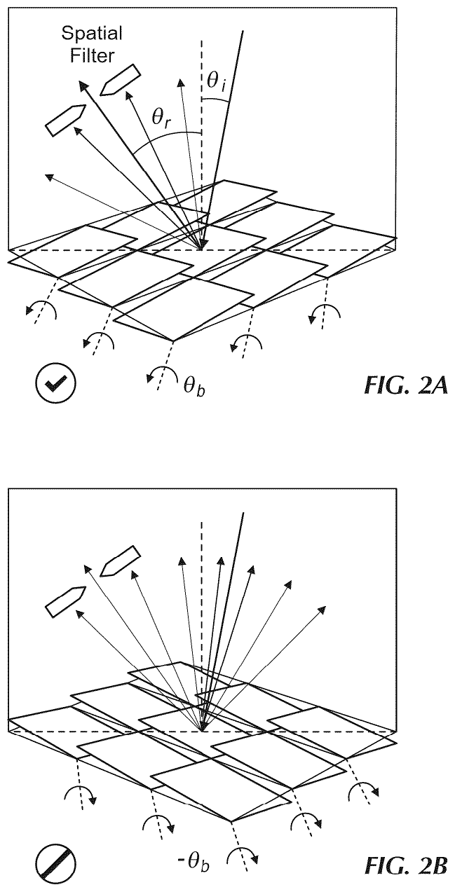

Referring to FIG. 2A, a DMD can be seen switching on secondary spots by satisfying a blazing condition, while in FIG. 2B, the DMD can be seen switching off secondary spots by violating the blazing condition.

The DMD parameters may dictate that the angle of incidence and reflection are relatively large, which makes it difficult to construct a single imaging system to focus and recollimate the spot array across the entire DMD aperture without aberrations (in one example setup, θᵢ=11.1° and θᵣ=35.8°). As an alternative to enable the use of off-the-shelf optics, one can implement separate imaging systems for the incident and outgoing beams, with tilted optical axes aligned to θᵢ and θᵣ, respectively. A consequence of this choice is that the DMD does not lie in the focal plane of the imaging system, which results in a position-dependent defocus and astigmatism across the DMD aperture.

However, these aberrations can be corrected by using a second, compensating diffraction grating after the DMD. Thus, referring to FIG. 1, the system may include a compensation grating 16 after the third modulator, in the path 10 of the secondary beams.

In some embodiments, the parameters of the telescope (magnification M) and the compensation grating

$$( {β}_{G} = \frac{cos ( {θ}_{r , G} )}{cos ( {θ}_{i , G}} )$$

may be chosen to minimize the following defocus in the image plane:

$${δ}_{x , I}^{′} = M [ M sin ( {θ}_{i , D} ) {β}_{D}^{2} {β}_{G}^{2} - M sin ( {θ}_{r , D} ) {β}_{G}^{2} + \frac{cos ( {θ}_{r , D} )}{cos ( {θ}_{i , D} )} [ sin ( {θ}_{i , G} ) {β}_{G}^{2} - sin ( {θ}_{r , G} ) ] ] X ,$$

$${δ}_{y , I}^{′} = M [ M sin ( {θ}_{i , D} ) - M sin ( {θ}_{r , D} ) + \frac{cos ( {θ}_{r , D} )}{cos ( {θ}_{i , D} )} [ sin ( {θ}_{i , G} ) - sin ( {θ}_{r , G} ) ] ] X .$$

In one example, the system could generate 10,005-spot arrays (87×115) with a separation of 4.6 w₀. This corresponds to approximately 210,000 diffraction-limited modes, essentially saturating the capacity of the DMD. In contrast, without the compensation grating, less than ⅓ of the DMD capacity is usable.

In some embodiments, a power efficiency (defined as the sum of the secondary beam powers divided by the incident primary beam power) may be substantially constant as the number of secondary beams is varied. In some embodiments, the power efficiency may vary as the number of secondary beams is varied.

The third modulator may be configured to switch a pattern of the secondary beams transmitted within any desirable period of time. In some embodiments, the third modulator may be configured to switch a pattern of secondary beams transmitted in no more than 50 microseconds. In some embodiments, the third modulator may be configured to switch a pattern of secondary beams transmitted in no more than 40 microseconds. In some embodiments, the third modulator may be configured to switch a pattern of secondary beams transmitted in no more than 30 microseconds. In some embodiments, the third modulator may be configured to switch a pattern of secondary beams transmitted in no more than 25 microseconds. In some embodiments, the third modulator may be configured to switch a pattern of secondary beams transmitted in no more than 23 microseconds. In some embodiments, the third modulator may be configured to switch a pattern of secondary beams transmitted in no more than 21 microseconds.

In some embodiments, a secondary beam may be switched off at the third modulator, and its intensity in the plane of the atoms may be reduced by an average of at least 46 dB. In some embodiments, its intensity in the plane of the atoms may be reduced by an average of at least 25 dB. In some embodiments, its intensity in the plane of the atoms may be reduced by an average of at least 30 dB. In some embodiments, its intensity in the plane of the atoms may be reduced by an average of at least 35 dB. In some embodiments, its intensity in the plane of the atoms may be reduced by an average of at least 40 dB.

In some embodiments, an array of secondary beams with spacing equal to twenty beam waists or less may be realized. In some embodiments, an array of secondary beams with spacing equal to fifteen beam waists or less may be realized. In some embodiments, an array of secondary beams with spacing equal to ten beam waists or less may be realized. In some embodiments, the spacing may be equal to nine beam waists or less. In some embodiments, the spacing may be equal to eight beam waists or less. In some embodiments, the spacing may be equal to seven beam waists or less. In some embodiments, the spacing may be equal to six beam waists or less. In some embodiments, the spacing may be equal to five beam waists or less. In some embodiments, an array of secondary beams with spacing equal to 4.6× beam waists or less may be realized.

In some embodiments (for example, at a spacing of 4.6× beam waists), the crosstalk in the image plane between a primary beam that is on and a neighboring site that is off may be, on average, 4e−5 (−43 dB) or less. In some embodiments, the average crosstalk at that spacing may be −20 dB or less. In some embodiments, the average crosstalk at that spacing may be −25 dB or less. In some embodiments, the average crosstalk at that spacing may be −30 dB or less. In some embodiments, the average crosstalk at that spacing may be −35 dB or less. In some embodiments, the average crosstalk at that spacing may be −40 dB or less.

Referring to FIG. 1, the system may include a telescope after the third modulator in the path of the secondary beams. The telescope may include one or more lenses 13, 15. The telescope may include a spatial filter and iris 14.

In some embodiments, with a fortuitous wavelength and DMD parameters combination, the telescope and compensation grating can be disposed of, while a wavefront pre-compensation is implemented using LCOS-SLM.

The system may include an objective lens 18 after the compensation grating, the objective lens configured to image the secondary beams onto a target 19, which may be, e.g., a camera, a photodiode, an atomic array, etc. The system may include one or more additional lenses 17 and/or mirrors between the compensating grating and the objective lens.

In some embodiments, a compensation grating is not used and instead a phase-only spatial light modulator (SLM) is used to pre-compensate defocus and astigmatism introduced by the DMD, by applying a site-dependent wavefront correction to the secondary beams.

In some embodiments, a phase-only spatial light modulator (SLM) is used to apply a site-dependent wavefront correction to the secondary beams to maintain a target or tight focus across the entire DMD aperture. In some embodiments, this may include, e.g., having a focus or defocus level across the entire DMD aperture that varies by less than 50%, less than 45%, less than 40%, less than 35%, less than 30%, less than 25%, less than 20%, less than 15%, less than 10%, less than 5%, less than 2%, or less than 1%.

In various aspects, a method for generating and steering a plurality of laser beams onto an array of atoms for performing locally addressed quantum gate operations may be provided. The method may include producing pulses of laser light that are configured to control a gate operation (e.g., with a pulsed laser, or with the first modulator as disclosed herein). As disclosed herein, the laser light may optionally be coupled into a single mode fiber to eliminate spatial effects.

The method may include imprinting a phase pattern on the beam (e.g., utilizing the second modulator as disclosed herein). The phase pattern may be chosen such that the single input beam is divided a pattern of secondary beams such that the positions of the beams correspond to the positions of the atoms or ions in a quantum computer, after passing through one or more lenses.

The method may include focusing the secondary beams to form an image on a digital micromirror device (DMD) amplitude modulator.

An angle of incidence onto the DMD may be chosen such that the reflected beam satisfies a blazing condition, so the reflected light is concentrated in a single diffraction order. A DMD plane may not be perpendicular to the propagation direction of the light from a phase-only spatial light modulator (SLM) configured to imprint the phase pattern.

The method may include flipping one or more mirrors on the DMD on or off to turn on or off individual beams of the secondary beams in the reflection from the DMD.

The method may include re-imaging the beams reflected from the DMD onto a plane of atoms or ions making up a quantum computer.

The method may include correcting aberrations caused by the DMD. This may include one or more post-compensation techniques, such as passing the beams reflected from the DMD through a telescope and compensation grating. This may include one or more pre-compensation techniques, such as using the wavefront correction capabilities of an LCOS-SLM to pre-compensate the aberrations. In some embodiments, only one of two compensation techniques is performed. In some embodiments, both pre- and post-compensation is performed.

The method may include using an objective lens to image the secondary beams onto a target, such as an atomic array.

### EXAMPLE

The primary laser beam is produced by a helium neon laser (632.8 nm), modulated by an AOM to produce pulses. The beam is then coupled into a single-mode fiber, and then back into free space in front of the LCOS-SLM. The collimator is a Schäfter+Kirchhoff 60FC-L-4-M40L-26, with a focal length of f=40 mm to create a beam waist of approximately 4 mm (1/e² radius). This is chosen to be approximately 60% of the semi-height of the Hamamatsu x15213-01 LCOS-SLM aperture to minimize diffraction from the aperture edges, which can lead to worse optical crosstalk in the image plane. The secondary beams generated by the LCOS-SLM were directed onto the DMD with a f=400 mm achromatic lens. The DMD is a DLP7000 chip from Texas Instruments, which has 1024×768 pixels, with a pitch size of a=13.68 μm, driven by a ViALUX V4395 controller. The specified blaze angle of the DLP7000 is 11°-13°, and a measurement of the specific device using the blazing efficiency reveals an angle of θ_{b,D}=12.35°. The angle of incidence (AOI, θ_{i,D}=11.1°) to the DMD plane is chosen to satisfy a blazing condition. After the DMD, a M=1:1 telescope made from f=200 mm achromatic lenses relays the modulated beams to a ruled grating (Edmund optics 41-025, 600 grooves/mm, θ_{b,G}=13°) at an AOI of θ_{i,G}=36.8°, to undo defocus and aberrations from the DMD.

The justification for the choices relates to aberration correction is based on the following. The dominant aberrations (defocus and astigmatism) can be computed in the plane of the DMD and in the final image plane. The aberrations in the image plane are significant when generating large spot arrays, but can be corrected using a compensation grating. The aberrations in the DMD plane are not a significant problem for the parameters of this example, but could limit the array size and crosstalk in certain cases including scaling to larger DMDs. In this case, a solution that combines a compensation grating and LCOS-SLM precompensation is proposed.

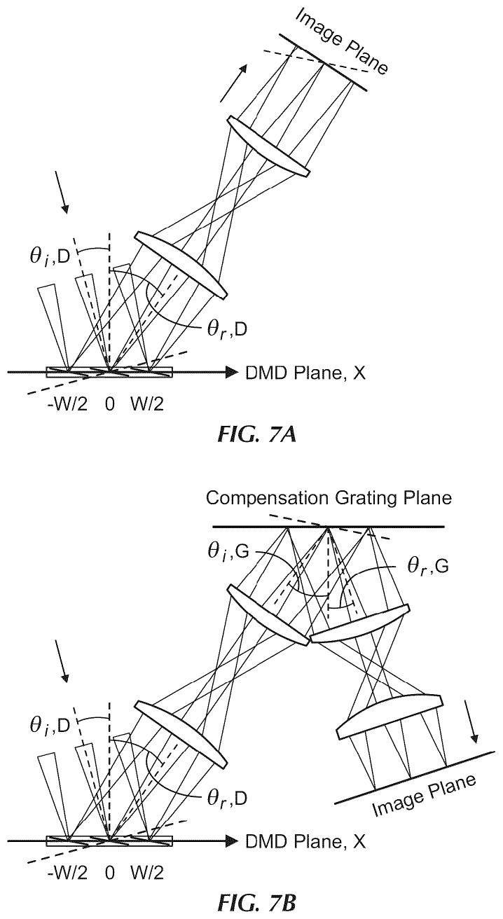

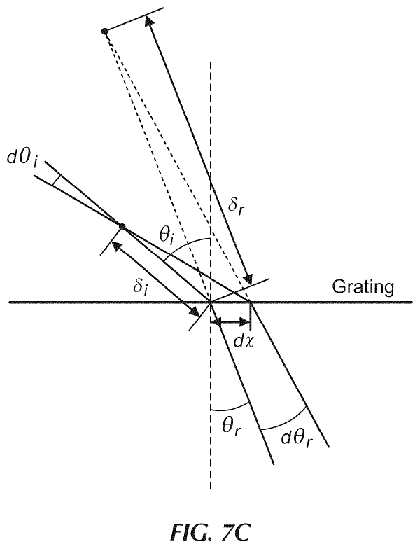

The aberrations are related to the tilted optical axes shown in FIG. 7A. The angle of incidence on the DMD, θ_{i,D}, is chosen to satisfy the blazing condition. As illustrated in FIG. 7A, for each order m, there is a pair of potential values for θ_{i,D}, given by:

$${θ}_{i , D} = \pm arccos ( \frac{- m λ}{2 d sin {θ}_{b}} ) - {θ}_{b} . \qquad ( 1 )$$

An m that guarantees arccos

$$( \frac{- m λ}{2 d sin {θ}_{b}} ) - {θ}_{b} > 0$$

is preferred, which ensures that the incident and exiting beams are well-separated. Additionally, |θ_{i,D}| preferably remains as small as possible in order to minimize optical power leakage through the gaps between tilted micromirrors, thereby achieving high power efficiency. A configuration satisfying

$${θ}_{i , D} = arccos ( \frac{- m λ}{2 d sin {θ}_{b}} ) - {θ}_{b} > 0 and {θ}_{r , D} = arccos ( \frac{- m λ}{2 d sin {θ}_{b}} ) + {θ}_{b} > 0$$

is depicted in FIG. 7A.

In this example, the aberrations are first computed in the image plane, which is the primary limitation in the current example. The grating nature of the DMD results in a misalignment between the image plane and the focal plane of the imaging system (see FIG. 7A). The defocus for rays in xz and yz planes are described by two linear functions dependent on the horizontal position X∈[−W/2, W/2] (where W is the width of the DMD aperture), and the slopes differ:

$$\frac{\partial {δ}_{x , I}}{\partial X} = ( sin {θ}_{i , D} {β}_{D}^{2} - sin {θ}_{r , D} ) , \qquad ( 2 )$$

$$\frac{\partial {δ}_{y , I}}{\partial X} = ( sin {θ}_{i , D} - sin {θ}_{r , D} ) , \qquad ( 3 )$$

where β_{D}=cos θ_{r,D}/cos θ_{i,D}. To achieve diffraction-limited performance, the defocus must meet the following conditions: δ_{x,I}(X)<ε_{I}z_{R} and δ_{y,I}(X)<ε_{I}z_{R}, where z_{R} is the Rayleigh length, ε_{I} is typically set to 0.3, ensuring that the P-V wavefront error stays below λ/10. For the DMD parameters and beam width (20.4 μm in the DMD plane) in this example, the condition is only satisfied over the central 28% of the DMD aperture.

The aberrations in the image plane can be corrected by adding a telescope (M) and a compensation grating (β_{G}=cos θ_{r,G}/cos θ_{i,G}) as illustrated in FIG. 7B. In this configuration, the final image plane slopes are:

$$\frac{\partial {δ}_{x , I}^{′}}{\partial X} = M [ M sin {θ}_{i , D} {β}_{D}^{2} {β}_{G}^{2} - M sin {θ}_{r , D} {β}_{G}^{2} + \frac{cos {θ}_{r , D}}{cos {θ}_{i , G}} ( sin {θ}_{i , G} {β}_{G}^{2} - sin {θ}_{r , G} ) ] , \qquad ( 4 )$$

$$\frac{\partial {δ}_{x , I}^{′}}{\partial X} = M [ M sin {θ}_{i , D} - M sin {θ}_{r , D} + \frac{cos {θ}_{r , D}}{cos {θ}_{i , G}} ( sin {θ}_{i , G} - sin {θ}_{r , G} ) ] . \qquad ( 5 )$$

These slopes can be simultaneously zeroes by adjusting M and β_{G}. However, given the discrete options for M and β_{G} using stock optical components, one can again consider a condition for maintaining a diffraction limited focus across the spot array:

$${δ}_{x , I}^{′} ( X ) < {ε}_{I} {z}_{R}^{′} and {δ}_{y , I}^{′} ( X ) < {ε}_{I} {z}_{R}^{′} ,$$

where:

$${z}_{R}^{′} = {M}^{2} {z}_{R}$$

denotes the new Kayleigh length after magnification. By selecting M=1, θ_{i,G}=36.8°, and θ_{r,G}=12.7°, one can achieve a maximum defocus in the image plane of 0.03z_{R} across the full DMD aperture (i.e., for |X|≤W/2).

One can then consider the defocus in the DMD plane. While defocused spots in the DMD plane do not necessarily impair the spot quality in the final image plane, it can lead to crosstalk if the spots begin to overlap on the DMD. The slope of the focal plane with response to the DMD is given by:

$$\frac{\partial {δ}_{D}}{\partial X} = sin {θ}_{i , D} \qquad ( 6 )$$

To avoid overlapping spots for an array with a spacing of Aw₀ (A>2), the defocus must satisfy

$$\vert X sin {θ}_{i , D} \vert < {ε}_{D} {z}_{R} = {ε}_{D} \frac{π {w}_{0}^{2}}{λ} ,$$

$$where$$

$${ε}_{D} = \sqrt{\frac{{A}^{2}}{4} - 1} ( {ε}_{D} = 2.1$$

when A=4.6). Given the wavelength, beam sizes, and DMD parameters used in this example, the defocus at the edge of the DMD aperture is δ_{D}(W/2)=0.8z_{R}, leading to a minimum spacing of Aₘᵢₙ=2.6, which is less than half the spacing used in this example.

It is also possible to use the wavefront correction capabilities of the second modulator (e.g., the LCOS-SLM) to pre-compensate the aberrations induced by the DMD, to achieve a uniform spot array in the image plan without using a compensation grating. This will necessarily exacerbate the aberrations in the DMD plane, but, as noted, these are not a significant constraint for the array parameters presented in this example. In this case, it is preferably to select an angle of incidence

$$\vert {θ}_{i , D} \vert = \vert - arccos ( \frac{- m λ}{2 d sin {θ}_{b}} ) - {θ}_{b} \vert ,$$

ensuring a minimal exiting angle

$$\vert {θ}_{r , D} \vert = \vert arccos ( \frac{- m λ}{2 d sin {θ}_{b}} ) - {θ}_{b} \vert .$$

For the DMD in this example, this would favor reversing the input and output paths.

Lastly, it is noted that pre- and post-compensation can be combined. For example, where it is desirable to scale to even larger number of spots (i.e., by decreasing the spacing or using DMDs with larger numbers of pixels), DMD-plane aberrations may become problematic. This can be addressed by using the SLM pre-compensation to remove the aberrations in this plane, at the expense of increasing the aberrations at the image plane. However, the image plane aberrations can subsequently be corrected with a telescope and compensation grating as disclosed herein.

Continuing with the assumption that the incident and exiting beams reside in the xz plane as discussed previously, the distance between the focal point and the grating plane may be designated as δᵢ=δ_{x,i}=δ_{y,i}, as illustrated in FIG. 7C. From the standpoint of geometrical optics, the focal point is identified as the intersection of plane waves with varying angles of incidence. A large beam waist, w₀>a>>λ, guarantees a slight divergence of these angles. Hence, an incidence angle can be written as:

$${θ}_{i} ( {k}_{x} ) = {θ}_{i} ( 0 ) + arctan ( {k}_{x} / {k}_{Z} ) \approx {θ}_{i} ( 0 ) + {k}_{x} / {k}_{z} , \qquad ( 7 )$$

where kₓ and k_{z} represent the wave vectors defining the direction of propagation. The exit angle is determined by the grating equation, sin(θᵣ)−sin(θᵢ)=mλ/d. Taking derivatives on both sides results in:

$$\frac{d {θ}_{r}}{d {θ}_{i}} = \frac{cos ( {θ}_{i} )}{cos ( {θ}_{r} )} , \qquad ( 8 )$$

meaning, after passing the grating, the new x wavevector becomes

$${k}_{x}^{′} = \frac{cos ( {θ}_{i} )}{cos ( {θ}_{r} )} {k}_{x} ,$$

whereas the new y wavevector remains

$${k}_{y}^{′} = {k}_{y} ,$$

since the grating vector is along the x direction.

In FIG. 7C, the intersection of two plane waves designate the focal point of the incident beam. The divergence angle of the two wave planes prior to the grating dθᵢ<<1, hence, the distance in the grating plane is approximately dx=δ_{x,i}dθᵢ/cos(θᵢ). The divergence angle of the exiting plane waves is also small

$$( d {θ}_{r} = d {θ}_{i} \frac{cos ( {θ}_{i} )}{cos ( {θ}_{r} )} << 1 ) .$$

Consequently, the effective focal point locations for rays in xz and yz planes post-diffraction can be established as, respectively

$${δ}_{x , r} = \frac{d x}{cos ( {θ}_{r} )} / d {θ}_{r} = {( cos ( {θ}_{r} ) / cos ( {θ}_{i} ) )}^{2} {δ}_{i} , \qquad ( 9 )$$

$${δ}_{y , r} = {δ}_{i} . \qquad ( 10 )$$

The occurrence of astigmatism is due to δ_{x,r}≠δ_{y,r}. It should be noted that astigmatism can also be deduced by decomposing a Gaussian beam into plane waves via a Fourier transform, applying Eq. 8 to plane waves, and then conducting an inverse Fourier transform.

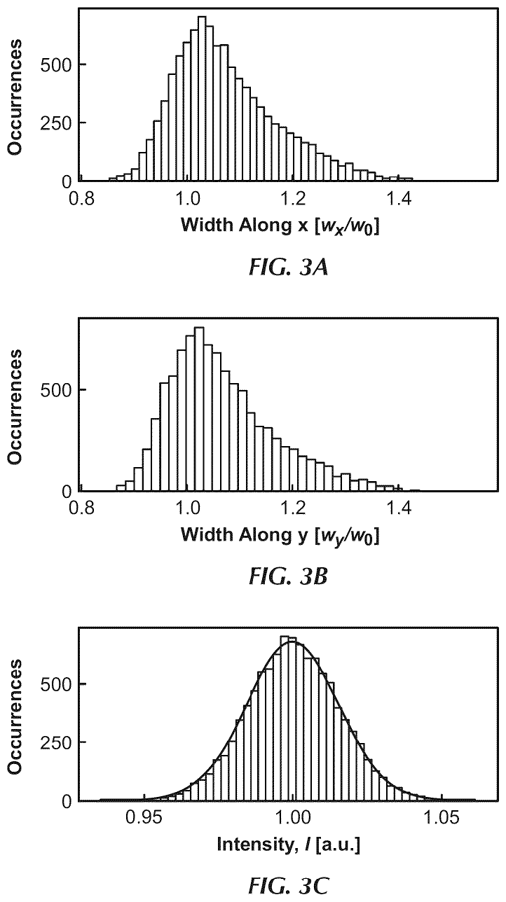

To characterize performance of the modulator, uniformity of a generated array was studied. In this example, the spot array was focused directly onto a camera (FLIR BFS-PGE-200S6C-C) using a f=300 mm lens and a f=200 mm achromatic doublet, resulting in a beam waist of w₀=17.2 μm. Across the 10,005-spot array, it was found that the beam waist had a standard deviation of approximately 10% (see FIGS. 3A-3B). The spot intensity was also characterized, after homogenizing the array with the LCOS-SLM using the weighted Gerchberg-Saxton algorithm, and it was found to have a standard deviation of 1.6% (see FIG. 3C). A significant fraction of the residual intensity non-uniformity arises from the 120 Hz flicker on LCOS-SLM, which may be made visible, e.g., by choosing a synchronous camera frame rate.

A figure of merit for locally addressed gate operations is the contrast (i.e., on/off intensity ratio of a single site) and crosstalk (i.e., unintentional illumination of sites around a target site caused by its tail).

Analytic and numerical models may be useful to understand the experimentally measured on/off contrast. The diffraction pattern produced by a single micromirror on the DMD manifests an intensity envelope that peaks in the direction of the micromirror's specular reflection. The interference further discretizes the diffraction envelope into separate peaks marked by orders in two directions (mₓ′, m_{y}′). In this example, one can define the x′ and the y′ axes by rotating the x and the y axes by 45°. This rotation aligns the new axes with the edges of the micromirrors. The diffraction envelopes peak along the x′ and the y′ axis, respectively, resulting in an enhanced contrast ratio for the diagonal orders (mₓ′=m_{y}′=m). The normalized optical power for a diagonal order m is given by the equation

$$I ( m ) = \frac{sin {c}^{4} [ \frac{π h}{\sqrt{2 λ}} ( sin {θ}_{r} ( m ) - sin ( {θ}_{i} + 2 {θ}_{b} ) ) ]}{\begin{matrix}{\sum }_{{m}_{{x}^{′}} , {m}_{{y}^{′}}} [ \frac{π h}{λ} ( sin {θ}_{r , {x}^{′}} ( {{m}^{′}}_{{x}^{′}} ) - \frac{sin ( {θ}_{i} + 2 {θ}_{b} )}{\sqrt{2}} ) ] \cdot sin {c}^{2} \\ [ \frac{π h}{λ} ( sin {θ}_{r , {y}^{′}} ( {{m}^{′}}_{{y}^{′}} ) - \frac{sin ( {θ}_{i} + 2 {θ}_{b} )}{\sqrt{2}} ) ]\end{matrix}}$$

where h is the width of a micromirror and θ_{r,x}′ (θ_{r,y}′) is the exiting angle in x′z (y′z) plane. The contrast anticipated theoretically (assuming an ideal 2D grating) is 5×10⁻⁷.

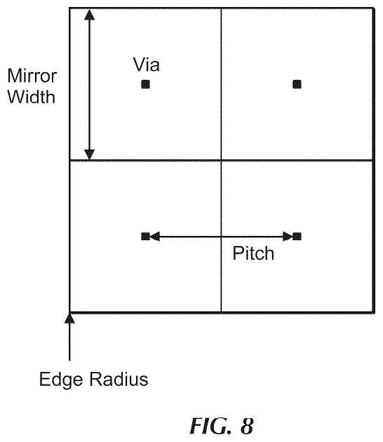

To understand the role of non-ideal effects in a realistic DMD, one can deploy an FDTD simulation to estimate the contrast. The physical dimensions of the model are depicted in FIG. 8. Here, one can establish the pitch size at 13.68 μm, the micromirror width at 13.14 μm, the via width at 0.75 μm, the via depth at 1.75 μm, the edge radius at 0.4 μm, and the micromirror tilt at 12.35°. It is worth noting that the micromirrors are layered with aluminum, but a perfect electric conductor is adopted as the material in the simulation to lessen the demand on computing resources. When the micromirrors are activated, approximately 70% of the total incident power is channeled into the desired order. Conversely, when the micromirrors are deactivated, the desired order is significantly distanced from the envelope's center, yielding an intensity 5.9×10⁻⁶ times that of the incident intensity.

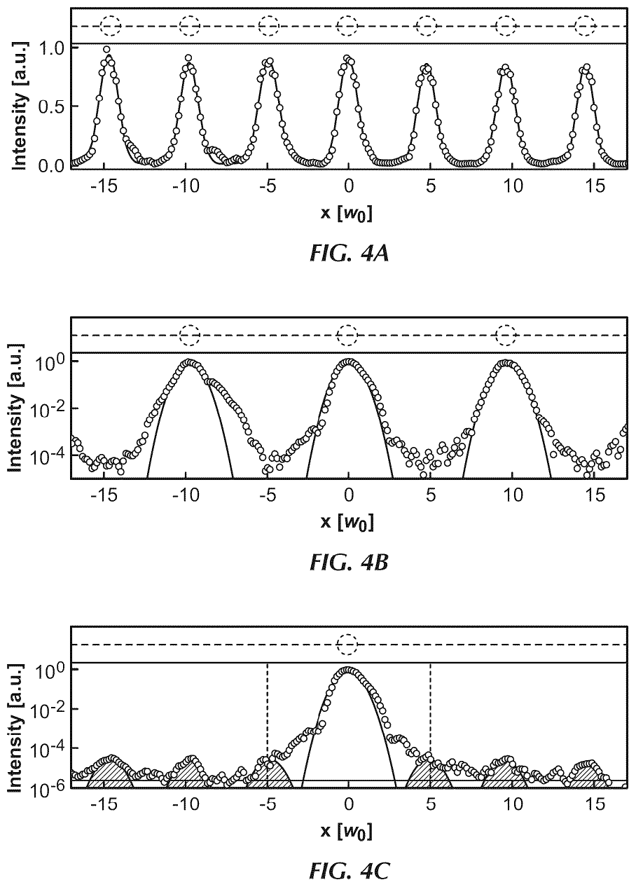

In FIGS. 4A-4C, a line cut of a single row of the array with all sites (4A), every other site (4B), and only one site (4C) illuminated are shown. In all cases, the LCOS-SLM is generating the full 10,005-site pattern, and a subset of sites is selected using the DMD only. By taking a series of images with logarithmically spaced exposure times (i.e., high dynamic range imaging), the intensity with a dynamic range of approximately 10⁶ can be recorded. In images with sparse illumination such as FIG. 4C, the average intensity at sites far from an illuminated site is 2.4×10⁻⁵ (−46 dB), which was defined as the contrast of the modulator. The intensity at sites adjacent to an illuminated site has an additional contribution from crosstalk, 4×10⁻⁵ (−44 dB). Remarkably, this performance is maintained across the entire array. Further, it was noted that the average crosstalk as a function of displacement from the illuminated site indicates a rapid decay with distance.

The high contrast results from the excellent extinction of light diffracted into the target order when the DMD mirrors are toggled, despite the fact that each local beam only addresses several DMD pixels. An ideal diffraction grating with the same parameters would yield a contrast of 5×10⁻⁷, (−63 dB) for a plane-wave input, and a finite-difference time-domain (FDTD) model incorporating realistic imperfections (e.g., finite fill factor, rounded corners and the hinge hole in the mirror center) predicts a contrast of 5.9×10⁻⁶ (−52 dB), closer to the experimental value. A quantitative model for the crosstalk onto nearest neighbor sites was not utilized, but it was noted that such crosstalk is extremely sensitive to aberrations (i.e., arising from the fiber collimator, clipping of the beam on apertures, including the DMD, and the precise alignment of the setup).

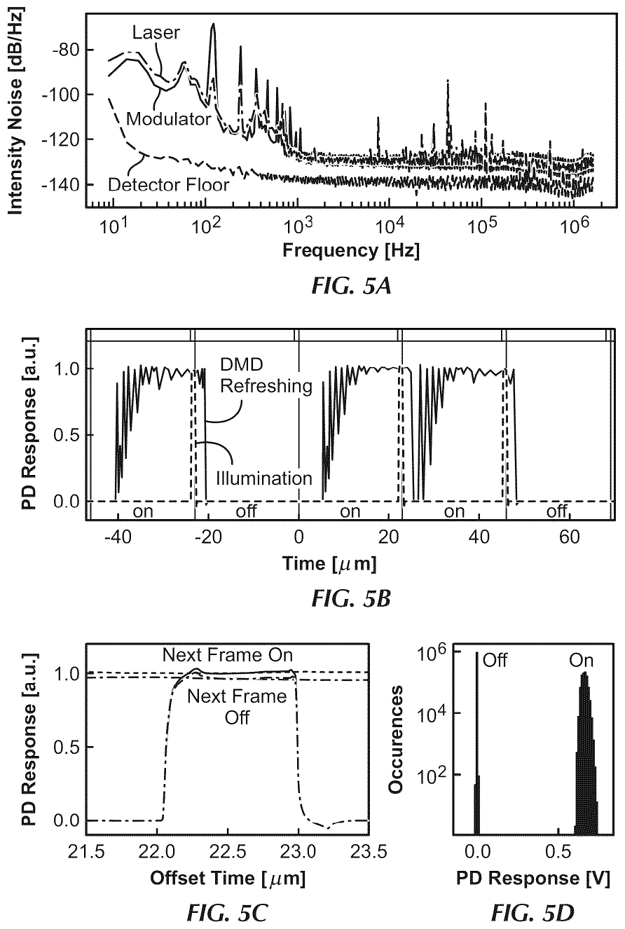

The dynamic performance of the system can be characterized. The camera can be replaced with a photodiode (Thorlabs APD130A), and the DMD can be configured to transmit only a single spot. The power spectral density under continuous illumination is shown in FIG. 5A. Relative to the source laser, the transmitted beam has added intensity noise at low frequencies, particularly 120 Hz and its harmonics, which can be attributed to flicker from the refresh rate of the LCOS-SLM. However, there is no measurable noise added at frequencies beyond 1 kHz. Next, the dynamics were characterized while switching the DMD mirrors (FIG. 5B). With continuous laser illumination, strong transients are visible when DMD micromirrors are switched. However, the intensity is stable after the mirrors have settled. At the full frame rate of 43 kHz, microsecond-long pulses can be applied during the stable region, exhibiting a high stability with a pulse flatness characterized by less than 0.8% intensity variation; longer stable windows can be achieved with slower frame rates. Unexpectedly, it was observed that the intensity changes by about 3% depending on the state of the mirrors in the next frame, which arises from a small electrostatic force on the mirror from the CMOS memory cell underneath, holding the next state of the mirror. Finally, the error rate was characterized using a pseudo-random sequence of 2 million frames at the full frame rate. No errors were observed, resulting in an upper bound of the bit error rate of 5×10⁻⁷ (see FIG. 5C). A photodiode response histogram with a 2-million-flip pseudorandom bit sequence applied on the DMD can be seen in FIG. 5D, showing no bit error (error rate upper bound 5.1×10⁻⁷).

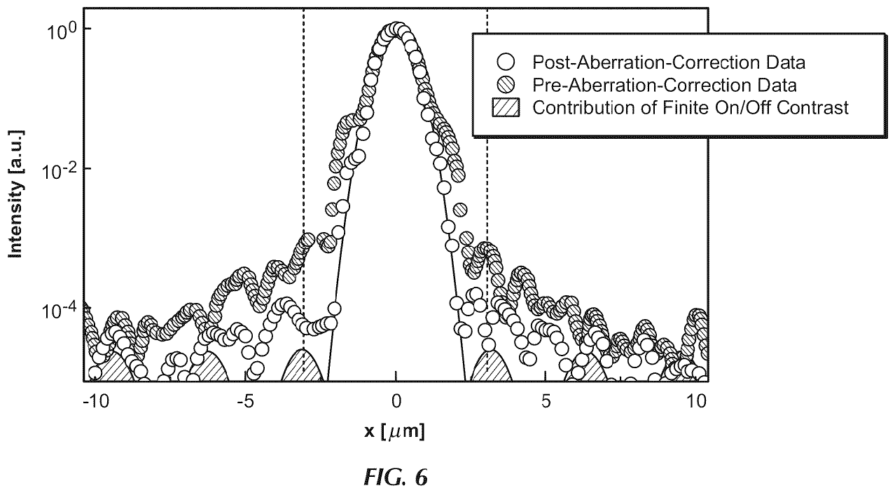

To model realistic experimental conditions in a neutral atom quantum computer, the achromatic doublet focusing lens was replaced with a microscope objective (Olympus Plan Achromat PLN20X, numerical aperture NA=0.4) to create an array with sub-micron spot sizes and 3.15 μm spacing. The resulting spots have a waist of 800 nm, characterized by re-imaging the array onto a camera using a higher NA objective ((Olympus Plan 40X Achromat Objective, NA=0.6). Distortion in this imaging system limits the accurate characterization to the central ~2,000 sites. After initial alignment, significantly degraded crosstalk was observed on nearest neighbor sites (approximately 7×10⁻⁴), attributed to aberrations in the microscope objective. However, iterative correction of these aberrations with the LCOS-SLM (applying an rms wavefront correction of ωsph=0.3 waves) suppresses the averaged crosstalk to 1.3×10⁻⁴, only slightly worse than what was observed with the doublet lens (see FIG. 6). Uniform performance was observed across the portion of the array that could be characterized.

Several aspects of the modulator performance can be commented upon. First, the achievable gate fidelity will depend on the specific approach to implementing local gate control. This modulator system is particularly well-suited to gates controlled by light shifts, particularly with nuclear spin qubits, as this approach is extremely robust to intensity fluctuations. In this case, the addressing errors will be predominantly from crosstalk, and will therefore be at the level of 10⁻⁴. On the other hand, gate implementations involving directly driving an atomic transition with a focused beam are more sensitive to intensity errors, though this can be mitigated through the design of robust gate pulses.

Second, while the example used a wavelength of 632.8 nm and a modest total power of 2 mW (0.2 μW/site), the underlying components can operate at wavelengths from 365 nm to beyond 1 μm, and at power levels up, e.g., 100 W, corresponding to 10 mW/site (depending on the wavelength and pulse duty cycle). The total power efficiency of the LCOS-SLM and DMD portion of the modulator is approximately 0.13 for a 10,000-spot array. The efficiency of the separate components is approximately 0.37 for the LCOS-SLM, 0.70 for the DMD, and 0.50 for the compensation grating.

Third, it is noted that the comparison between the performance obtained with an achromatic doublet lens (FIGS. 3A-4C), and a microscope objective (FIG. 6) illustrates the role of even very low levels of aberrations on the crosstalk and contrast. To obtain optimal performance with qubits, it will be necessary to implement techniques for in situ characterization of aberrations. In this context, the LCOS-SLM is beneficial for performing fine adjustments of the aberrations.

For smaller arrays or fortuitous combinations of wavelength and DMD blaze angle, the aberrations from misalignment of the DMD with the image plane are small enough that they can be pre-compensated with the LCOS-SLM as disclosed herein. However, the compensation grating presented here allows the LCOS-SLM to be replaced with other modulators with less flexible wavefront shaping, such as AODs. The combination of AODs and a DMD may provide greater power efficiency when driving gates on a very sparse subset of the entire array. Additionally, the ability to selectively switch off sites may enable new avenues for optical tweezer rearrangement.

Finally, possibilities for scaling to larger arrays and realizing faster switching are considered. The 10,000-site array in the present work corresponds to 210,000 diffraction-limited modes, when considering the spacing of 4.6w₀. This is close to the Nyquist limit for both the LCOS-SLM and the DMD, which have approximately 1 megapixel of resolution. Given the aberration control demonstrated in this work, scaling to larger arrays should be straightforward with higher resolution modulators or by tiling multiple modulators. While higher resolution LCOS-SLMs are available, it is noted that the flicker performance typically worsens with smaller pixels. The DMD switching speed is limited by both the data transfer rate and the mechanical response time of the pixels. An improvement of one order of magnitude could be achieved by using smaller micromirrors and grouping them together electrically to reduce the data rate.

Various modifications may be made to the systems, methods, apparatus, mechanisms, techniques, and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method for generating and steering a plurality of laser beams onto an array of atoms for performing locally addressed quantum gate operations, comprising:
producing, by a first modulator, a single input beam of light comprising pulses of laser light that are configured to control a gate operation;
imprinting, by a second modulator, a phase pattern on the single input beam, the phase pattern being chosen such that after a lens positioned after the second modulator, the single input beam is divided into a pattern of secondary beams that correspond to positions of atoms or ions in a quantum computer,
forming an image on a third modulator, by the lens after the second modulator being positioned so the secondary beams are focused to form an image on the third modulator, the third modulator being a digital micromirror device (DMD) amplitude modulator;
a compensation grating after the third modulator, in a path of the secondary beams; and
imaging the secondary beams onto a target by an objective lens after the third modulator and the compensation grating.

2. The method of claim 1, wherein the first modulator is an acousto-optic modulator or an electro-optic modulator.

3. The method of claim 1, wherein the single input beam is provided by a pulsed laser.

4. The method of claim 1, wherein the second modulator is one or more phase-only spatial light modulators (SLMs) or acoustic-optical deflectors (AODs).

5. The method of claim 1,
eliminating spatial effects based on the first modulator being operably coupled to a single mode fiber.

6. The method of claim 1, wherein the pattern of secondary beams comprises 10,000 secondary beams or less.

7. The method of claim 6, wherein each of the secondary beams is regularly spaced.

8. The method of claim 6, wherein one or more of the secondary beams is irregularly spaced.

9. The method of claim 1, wherein the pattern of secondary beams comprises more than 10,000 secondary beams.

10. The method of claim 1, wherein at least one pulse of the pulses of laser light is at least 10 ns in length.

11. The method of claim 1, wherein at least one pulse of the pulses of laser light is no more than 10 microseconds in length.

12. The method of claim 1, wherein the third modulator is configured to shut off a subset of the secondary beams.

13. A method for generating and steering a plurality of laser beams onto an array of atoms for performing locally addressed quantum gate operations, comprising:
producing pulses of laser light that are configured to control a gate operation, that is coupled into a single mode fiber to eliminate spatial effects, in a single input beam;
imprinting a phase pattern on the single input beam, the phase pattern chosen such that after a lens, the single input beam is divided a pattern of secondary beams that correspond to positions of atoms or ions in a quantum computer;
focusing the secondary beams to form an image on a digital micromirror device (DMD) amplitude modulator;
flipping one or more mirrors on the DMD amplitude modulator on or off to turn on or off individual beams of the secondary beams in a reflection from the DMD amplitude modulator; and
re-imaging the individual beams reflected from the DMD amplitude modulator onto a plane of atoms or ions making up a quantum computer.

14. The method of claim 13, wherein an angle of incidence onto the DMD amplitude modulator is chosen such that a reflected beam satisfies a blazing condition, so the reflected beam is concentrated in a single diffraction order.

15. The method of claim 13, wherein a DMD plane is not perpendicular to a propagation direction of light from a phase-only spatial light modulator (SLM) configured to imprint the phase pattern.

16. The method of claim 13, further comprising passing beams reflected from the DMD through a telescope and a compensation grating.

17. The method of claim 16, wherein parameters of the telescope (magnification M) and compensation grating
$$( {β}_{G} = \frac{cos ( {θ}_{r , G} )}{cos ( {θ}_{i , G} )} )$$
are chosen to minimize a defocus in an image plane as follows:
$${δ}_{x , I}^{′} = M [ M sin ( {θ}_{i , D} ) {β}_{D}^{2} {β}_{G}^{2} - M sin ( {θ}_{r , D} ) {β}_{G}^{2} + \frac{cos ( {θ}_{r , D} )}{cos ( {θ}_{i , D} )} [ sin ( {θ}_{i , G} ) {β}_{G}^{2} - sin ( {θ}_{r , G} ) ] ] X ,$$
$$and$$
$${δ}_{y , I}^{′} = M [ M sin ( {θ}_{i , D} ) - M sin ( {θ}_{r , D} ) + \frac{cos ( {θ}_{r , D} )}{cos ( {θ}_{i , D} )} [ sin ( {θ}_{i , G} ) - sin ( {θ}_{r , G} ) ] ] X .$$

18. The method of claim 16, further comprising using an objective lens to image the secondary beams onto an atomic array.

19. The method of claim 13, wherein a compensation grating is not used and instead a phase-only spatial light modulator (SLM) is used to pre-compensate defocus and astigmatism introduced by the DMD, by applying a site-dependent wavefront correction to the secondary beams.

20. The method of claim 13, where a phase-only spatial light modulator (SLM) is used to apply a site-dependent wavefront correction to the secondary beams to maintain a tight focus across all of a DMD aperture.
